(19) United States
(12) Patent Application Publication
(10) Pub. No.: US 2015/0365849 A1
(43) Pub. Date: Dec. 17, 2015

(54) HANDOVER PROCEDURE BETWEEN LOCAL AREA CELLS WHICH ARE UNDER THE SAME COVERAGE OF A MACRO CELL

(71) Applicants: Xinying GAO, Chaoyang District, Beijing (CN); Wei BAI, Chaoyang District, Beijing (CN); Jing HAN, Chaoyang District, Beijing (CN); Lili ZHANG, Haidian District, Beijing (CN); Haiming WANG, Chaoyang District, Beijing (CN); Pengfei SUN, Tongzhou District, Beijing (CN); BROADCOM CORPORATION, Irvine, CA (US)

(72) Inventors: Xinying GAO, Beijing (CN); Wei BAI, Beijing (CN); Jing HAN, Beijing (CN); Lili ZHANG, Beijing (CN); Haiming WANG, Beijing (CN); Pengfei SUN, Beijing (CN)

(73) Assignee: BROADCOM CORPORATION, Irvine, CA (US)

(21) Appl. No.: 14/765,132

(22) PCT Filed: Feb. 7, 2013
(86) PCT No.: PCT/CN2013/071519

§ 371 Date: Jul. 31, 2015

(51) Int. Cl. H04W 36/00

(52) U.S. Cl. CPC H04W 36/0016

(57) ABSTRACT

An apparatus and a method is provided, by which a first type cell is controlled, wherein a plurality of second type cells are located in the same area as the first type cell, wherein control signal transmission to at least one user equipment is carried out via the first type cell and data transmission to the at least one user equipment is carried out via one of a plurality of the second type cells, and handover of data transmission of a user equipment from a source cell being one of the plurality of second type cells to a target cell being another one of the plurality of second type cells is controlled. Moreover, also an apparatus and a method of e.g., a user equipment are provided, by which a handover of data transmission from a source cell being one of the plurality of second type cells to a target cell being another one of the plurality of second type cells is performed, while maintaining control signal transmission with the first type cell.

### FIELD OF THE INVENTION

The present invention relates to methods, devices and computer program products which enable a handover procedure between local area cells which are under the same coverage of a macro cell, and in more detail a simplified handover procedure for C/U-plane split LA cells, i.e., local area cells in which control plane and user plane are split.

### BACKGROUND

The following meanings for the abbreviations used in this specification apply:
3GPP 3^{rd} Generation Partnership Project
BB BaseBand
CA Carrier Aggregation
C-RNTI Cell Radio Network Temporary Identifier
DRB Data Radio Bearer
eNB Enhanced Node B
HO HandOver
LTE-A Long Term Evolution Advanced
MAC Media Access Control
MME Mobility Management Entity
PDCP Packet Data Convergence Protocol
RACH Random Access CHannel
RLC Radio Link Control
RRC Radio Resource Control
RRH Remote Radio Head
SRB Signaling Radio Bearer
TA Time Advance
UE User Equipment

Due to the recent booming of the wireless internet, it is easily expected that the requirement for wireless data service will keep on fast soaring in the near future. Among those advanced technologies proposed to meet the challenging request, reducing the cell size is one of the most prominent one. In the past 50 years, the wireless network capacity has been increased by more than 2700 times from smaller cells. Therefore, the local area (LA) network will inevitably become the next research hotspot in LTE evolution.

In the scenario of densely deployed LA cells under the coverage of macro cell, split of C-plane and U-plane between macro and small cells is proposed recently as a new strategy for efficient transmission in LA network. For C-plane, macro cell maintains good connectivity and mobility using lower existing frequency bands. While for U-plane, small cell provides higher throughput and more flexible/cost-energy efficient operations using higher/wider frequency bands. Small cell with new carrier type, called as “Phantom cell”, has been proposed (3GPP RWS-120010, Requirements, Candidate Solutions & Technology Roadmap for LTE Rel-12 Onward, NTT DOCOMO, INC.), which is not a conventional “cell” because of removing conventional cell-specific signals/channels, i.e., PSS/SSS, CRS, MIB/SIB, etc. The similar concept is also called as inter-eNB CA, dual connection, multi-stream etc., and proposed by many companies during Rel-12 workshop (e.g., 3GPP RWS-120003, Views on Rel-12, Ericsson & ST-Ericsson; 3GPP RWS-120006, Views on Rel-12 and onwards for LTE and UMTS, Huawei Technologies, HiSilicon).

Under the C/U-plane split assumption, when UE connects to macro eNB (MeNB) and local area eNB (LAeNB) simultaneously, MeNB can control the UE's mobility to avoid too many handover procedures and UE can enjoy the high data rate and low transmission power in LA cell. However, it is not clear how to perform handover when UE moves across LA cells under the same macro coverage in the current stage.

### SUMMARY

The present invention addresses such situation and aims to provide a reliable way of performing a handover between local area cells which are under the same coverage of a macro cell.

Various aspects of examples of the invention are set out in the claims.

According to a first aspect of the present invention, there is provided an apparatus comprising at least one processor, and at least one memory including computer program code, the at least one memory and the computer program being configured to, with the at least one processor, cause the apparatus to control a first type cell, wherein a plurality of second type cells are located in the same area as the first type cell, wherein control signal transmission to at least one user equipment is carried out via the first type cell and data transmission to the at least one user equipment is carried out via one of a plurality of the second type cells, and to control handover of data transmission of a user equipment from a source cell being one of the plurality of second type cells to a target cell being another one of the plurality of second type cells.

According to a second aspect of the present invention, there is provided an apparatus comprising at least one processor, and at least one memory including computer program code, the at least one memory and the computer program being configured to, with the at least one processor, cause the apparatus to have control signal transmission with a first type cell and data transmission with one of a plurality of second type cells, wherein the plurality of second type cells are located in the same area as the first type cell, and to perform a handover of data transmission from a source cell being one of the plurality of second type cells to a target cell being another one of the plurality of second type cells, while maintaining control signal transmission with the first type cell.

According to a third aspect of the present invention, there is provided a method comprising
controlling a first type cell, wherein a plurality of second type cells are located in the same area as the first type cell, wherein control signal transmission to at least one user equipment is carried out via the first type cell and data transmission to the at least one user equipment is carried out via one of a plurality of the second type cells, and
controlling handover of data transmission of a user equipment from a source cell being one of the plurality of second type cells to a target cell being another one of the plurality of second type cells.

According to a fourth aspect of the present invention, there is provided a method comprising
having control signal transmission with a first type cell and data transmission with one of a plurality of second type cells, wherein the plurality of second type cells are located in the same area as the first type cell, and
performing a handover of data transmission from a source cell being one of the plurality of second type cells to a target cell being another one of the plurality of second type cells, while maintaining control signal transmission with the first type cell.

The aspects described above may be modified as set out in the dependent claims.

According to a further aspect to the present invention, there is provided a computer program product comprising computer-executable components which, when executed on a computer, are configured to carry out the method as defined in any one of the third and fourth aspects and their modifications.

Thus, according to embodiments of the present invention, a handover of a user equipment from one local area cell to another local area cell, which are both located in the same macro cell, is fully controlled by the macro cell. Thus, the handover can be performed reliably and also signaling involved in the handover can be reduced.

### BRIEF DESCRIPTION OF DRAWINGS

For a more complete understanding of example embodiments of the present invention, reference is now made to the following descriptions taken in connection with the accompanying drawings in which:

FIGS. 1A and 1B show simplified structures of an MeNB and a UE according to embodiments of the present invention,

FIG. 2 shows an architecture of LA cells with C/U-plane split,

FIGS. 3A and 3B show an example for a handover procedure in LTE Rel-8/9/10,

FIG. 4 shows an example for a current RRC connection control procedure, and

FIG. 5 shows simplified HO procedure under C/U plane split according to an embodiment of the present invention.

### DESCRIPTION OF EXEMPLARY EMBODIMENTS

Exemplary aspects of the invention will be described herein below.

It is to be noted that the following exemplary description refers to an environment of the LTE system (long term evolution) and/or local area networks thereof. However, it is to be understood that this serves for explanatory purposes only. Other systems differing from the LTE system can be adopted.

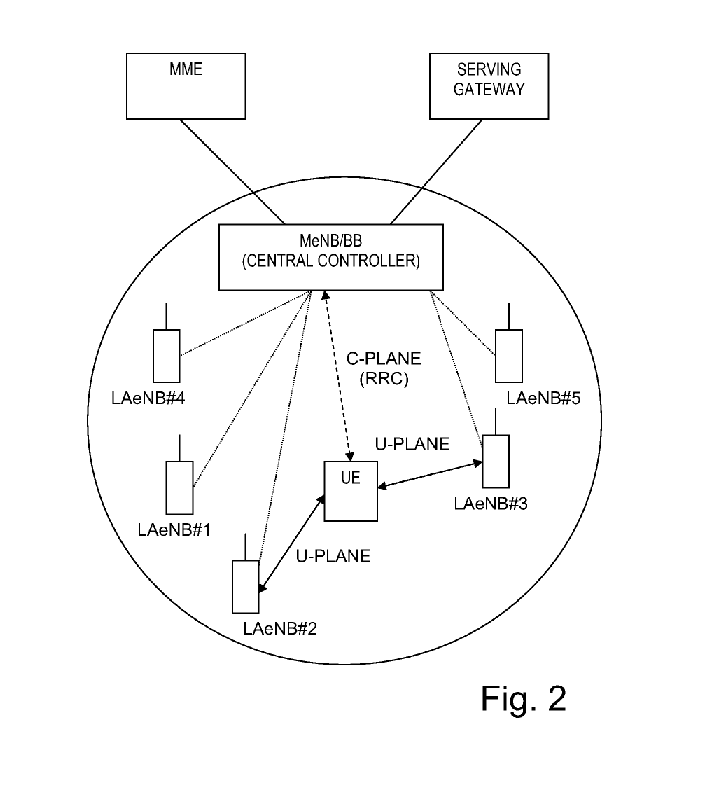

However, before explaining embodiments of the invention in detail, the problem underlying the present application is described in some more detail by referring to FIGS. 2 to 4 in the following.

In the scenario illustrated in FIG. 2, MeNB and baseband (BB) units of all LAeNBs are located at the same place. MeNB works as a central controller for all the LAeNBs, and all the PDCP, RLC entities are integrated in BB units. In the macro cell coverage, only MeNB is connected to the MME and serving gateway. All the LAeNBs are connected with MeNB via optical fiber. Each LAeNB has its own MAC scheduler. This is the main difference from the remote radio heads (RRHs) in carrier aggregation (CA) scenarios (as described in, e.g., 3GPP TS 36.300). The benefit of LA cells architecture considered in this IR is that it is efficient for easy deployment of LAeNBs with minimum impact on the MeNB.

When UE moves across LA cells, C-plane (i.e. SRBs) is maintained at MeNB, and only U-plane (i.e. DRBs) needs to be changed from source LAeNB to target LAeNB. Currently, there isn't any scheme available for handover in this case. In the following, a simplified handover procedure is developed based on current RRC re-establishment/reconfiguration procedure.

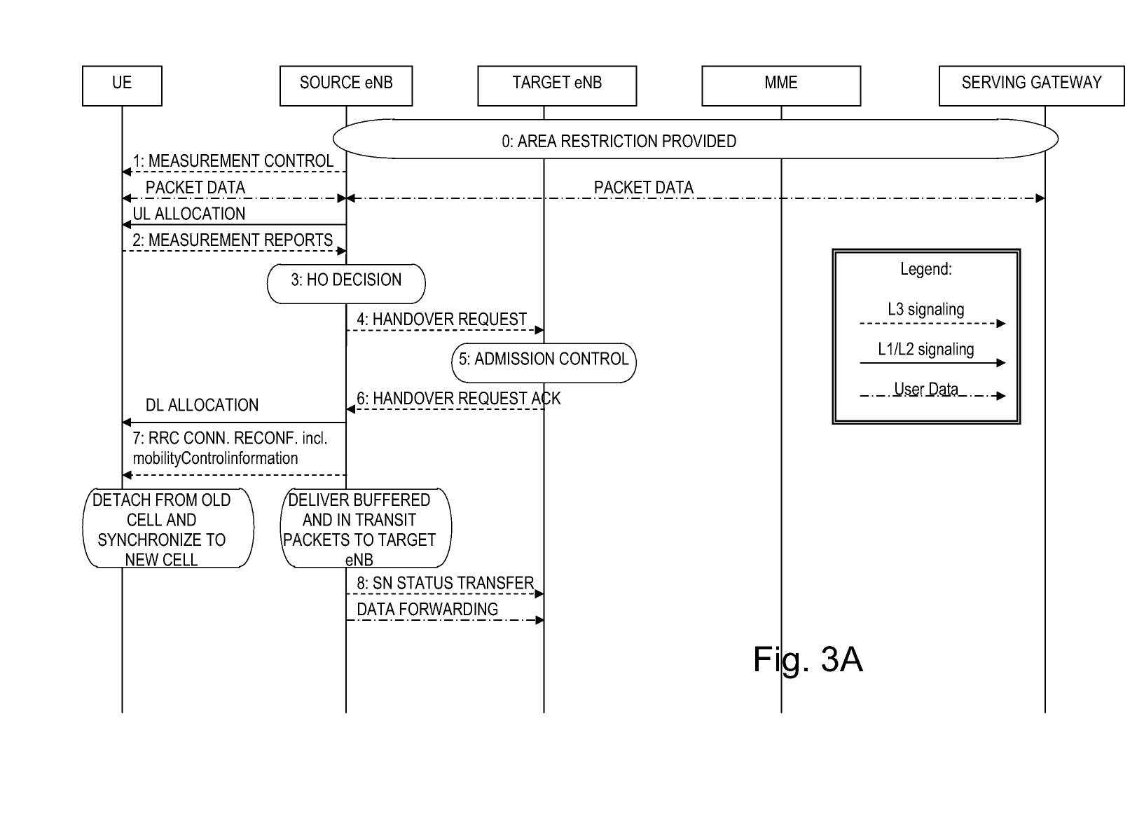

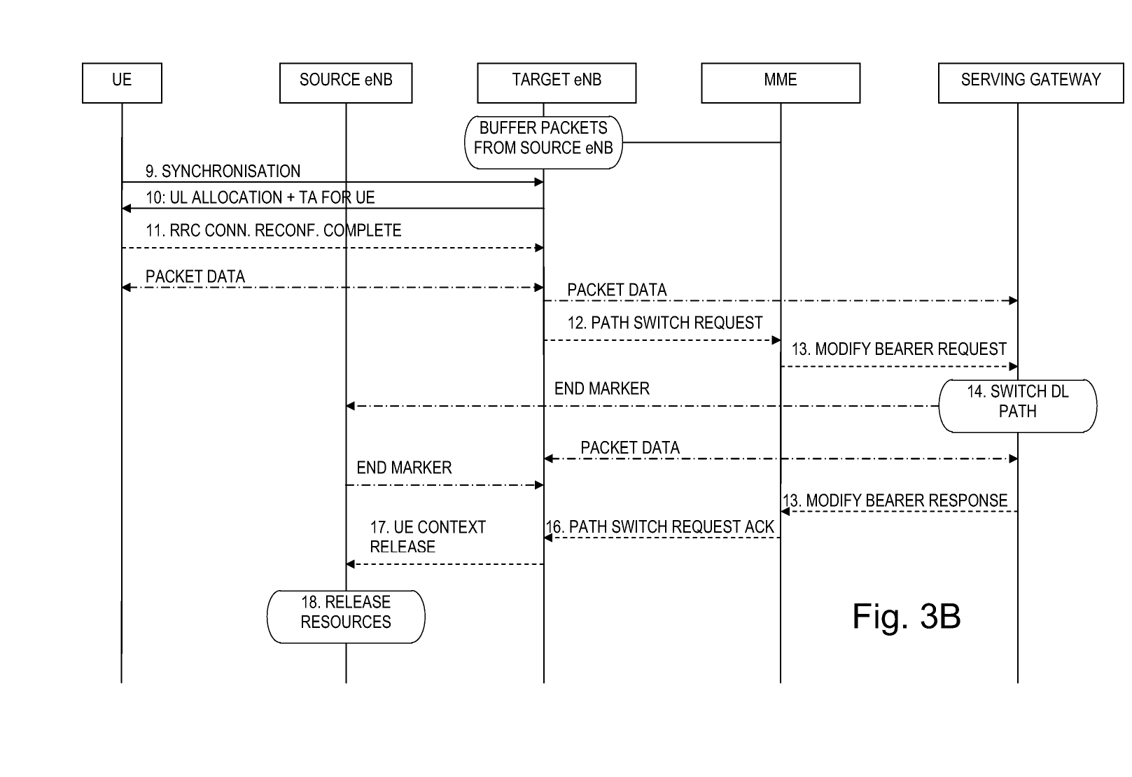

Current handover procedure e.g. for intra-MME/SGW is illustrated in FIGS. 3A and 3B, which reproduces FIG. 10.1.2.1.1-1: Intra-MME/Serving Gateway HO from section 10 in 3GPP TS 36.300 V11.4.0 (2012-12), to which it is also referred for further details. In particular, it is referred to section 10.1.2., in 10.1.2.1 of 3GPP TS 36.300 V11.4.0 (2012-12) in which this process is described in detail: :It is noted that the processes from in steps 4 to 7 describe handover preparation, steps 8 to 11 describe handover execution and steps 12 to 18 describe handover completion.

The details of UE's behavior during handover can be referred to section 5.3.5.4 in 3GPP TS 36.331, V11.2.0 (2012-12), Radio Resource Control.

But under C/U-plane split consideration, when UE moves across LA cells, SRBs are maintained at MeNB, and BB units are integrated with MeNB together, so that the MME and serving gateway are not necessary to be involved to handover procedure for path switch.

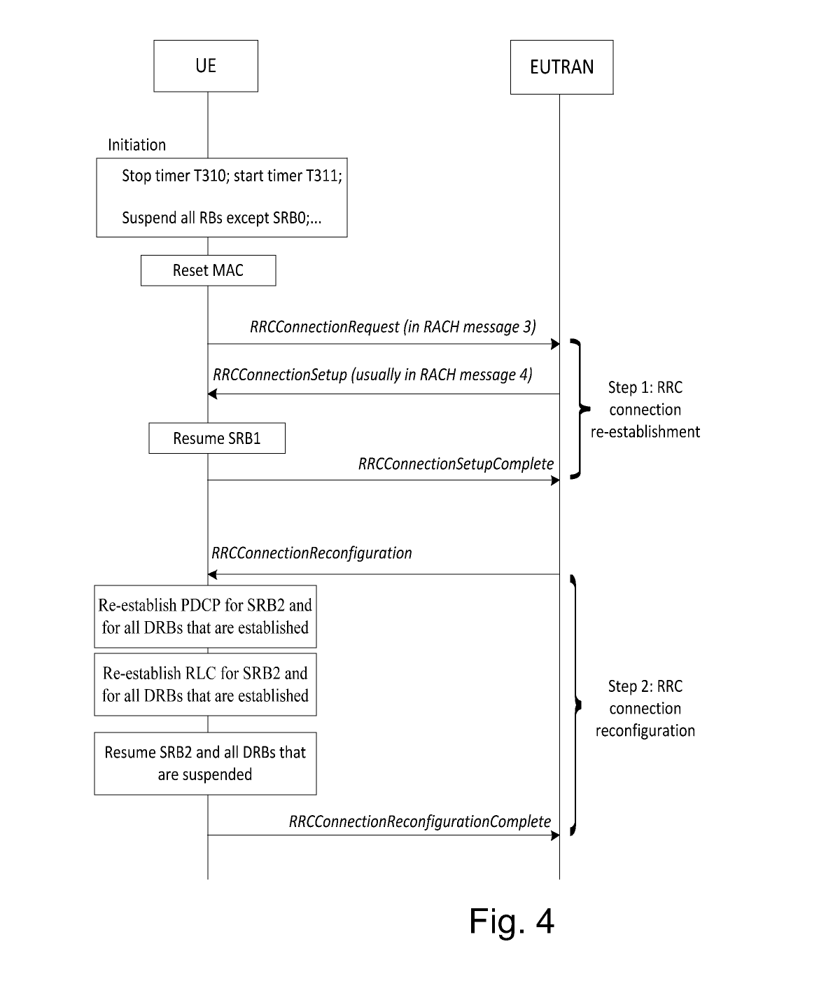

Normal procedure about RBs establishment, modification and release can be found in 3GPP TS 36.331, V11.2.0 (2012-12). By referring to the procedures of RRC connection re-establishment and RRC connection reconfiguration, the operations for SRBs and DRBs are shown in FIG. 4. It is derivable that
Upon initiation of the procedure, the UE shall suspend all RBs except SRB0 after some timers processing; and MAC is reset.
In RRC connection re-establishment procedure, SRB1 is resumed;
In RRC connection reconfiguration procedure, re-establish PDCP for SRB2 and for all DRBs that are established; re-establish RLC for SRB2 and for all DRBs that are established; and then SRB2 and all DRBs that are suspended are resumed.

Embodiments of the present invention, aim to provide a reliable and easily implementable simplified handover procedure under C/U-plane split assumption for capable Rel-12 UEs and eNBs, as described above.

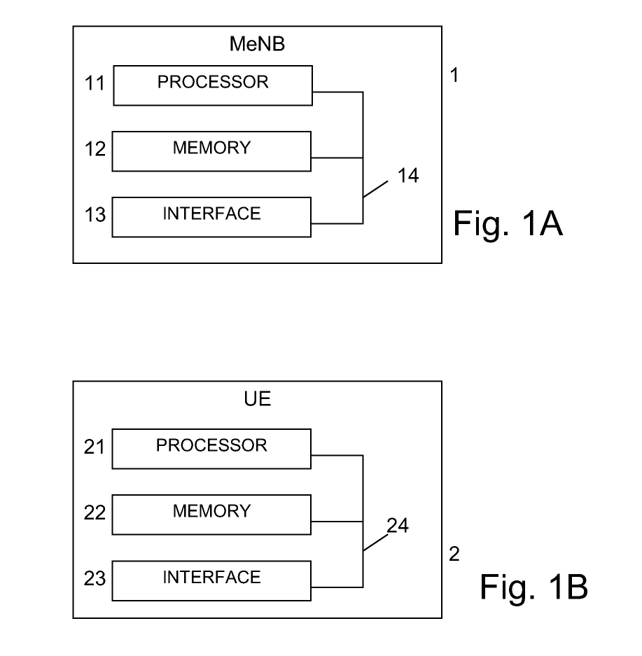

In the following, general embodiments for achieving this are described by referring to FIGS. 1A and 1B.

FIG. 1A illustrates a simplified block diagram of an MeNB 1 as an example for a corresponding apparatus according to an embodiment of the present invention. It is noted that the corresponding apparatus according to the embodiment may consist only of parts of the MeNB, so that the apparatus may be installed in an eNB, for example. Moreover, also the MeNB is only an example and may be replaced by another suitable network element.

The MeNB 1 according to this embodiment comprises a processor 11 and a memory 12. The memory comprises a computer program, wherein the memory 12 and the computer program are configured to, with the processor, cause the apparatus to control a first type cell (e.g., a macro cell), wherein a plurality of second type cells (e.g., LA cells) are located in the same area as the first type cell, wherein control signal transmission to at least one user equipment is carried out via the first type cell and data transmission to the at least one user equipment is carried out via one of a plurality of the second type cells, and to control handover of data transmission of a user equipment from a source cell being one of the plurality of second type cells to a target cell being another one of the plurality of second type cells.

FIG. 1B illustrates a simplified block diagram of an UE 2 as an example for a corresponding apparatus according to an embodiment of the present invention. It is noted that the corresponding apparatus according to the embodiment may consist only of parts of the UE, so that the apparatus may be installed in an UE, for example. Moreover, also the UE is only an example and may be replaced by another suitable network element.

The UE 2 according to this embodiment comprises a processor 21 and a memory 22. The memory comprises a computer program, wherein the memory 22 and the computer program are configured to, with the processor 21, cause the apparatus to have a control signal transmission with a first type cell and a control signal transmission with one of a plurality of second type cells, wherein the plurality of second type cells are located in the same area as the first type cell, and to perform a handover of data transmission from a source cell being one of the plurality of second type cells to a target cell being another one of the plurality of second type cells, while maintaining control signal with the first type cell.

Thus, according to embodiments, a handover can be carried out in a C/U-plane split assumption, i.e., wherein the handover is carried out only in data transmission (between second type cells), but not in control signaling transmission (which is maintained with the first type cell).

The handover decision can be referred to as a simplified handover decision, which is carried out by the apparatus controlling the first type cell (e.g., the MeNB 1). The decision may be based on measurements performed by the user equipment. After performing the handover decision, the user equipment may be instructed to reconfigure a radio resource connection with the target cell and to maintain control signal connection with the first type cell.

Optionally, the MeNB 1 and the UE 2 may also respectively comprise an interface 13 or 23 for providing connections to other network elements. Moreover, the processor 11 or 21, the memory 12 or 22, and the interface 13 or 23 may be respectively inter-connected by a suitable connection 14 or 24, e.g., a bus or the like. Moreover, it is noted that the apparatuses may comprise more than one processor, more than one memory and/or more than one interface, if this is suitable for a particular structure.

In the following, a more detailed embodiment is described.

According to embodiments of the present invention, as already described above in more general terms by referring to FIGS. 1A and 1B, a new procedure is introduced to enable simplified handover under C/U-plane split assumption for future LA network with MeNB/BB as central controller, and define the UE behavior of only handling DRBs as well as the related network operation.

In the present embodiment, the following assumptions are made: MeNB denotes a Macro eNB, and LAeNB denote a Local Area eNB, respectively. C-plane, or SRBs are established at MeNB. U-plane, or DRBs are established at LAeNB. PDCP, RLC entities are integrated in BB, while MAC and PHY are configured in each LAeNB.

According to a first item of the present embodiment, the simplified HO procedure is controlled by MeNB, in which a measurement procedure that supports simplified HO is configured by MeNB, and measurement report from UE is sent to MeNB. Moreover, the simplified HO decision is made at MeNB.

According to a second item of the present embodiment, the MeNB shall send some kind of indicator together with a RRCConnectionReconfiguration message to the UE. The RRCConnectionReconfiguration message is an example for a command for the UE to reconfigure a radio resource connection with the target LAeNB (as an example for a target cell) and to maintain control signal connection with the MeNB (as an example for the first type cell).

The RRCConnectionReconfiguration message does not include the mobilityControlInformation. MeNB sends a suspending indicator explicitly to UE. When UE receives this, it suspends all the DRBs which are served by LA cells. After DRBs suspension, the UE resets MAC.

According to a third item of the present embodiment, after the UE has successfully accessed the target LA cell, UE resumes all the suspended DRBs. After resumption, UE sends RRCConnectionReconfigurationComplete message to MeNB.

It is noted that PDCP and RLC re-establishments, data forwarding, security parameters updating are not needed due to the same BB units for all LAeNBs.

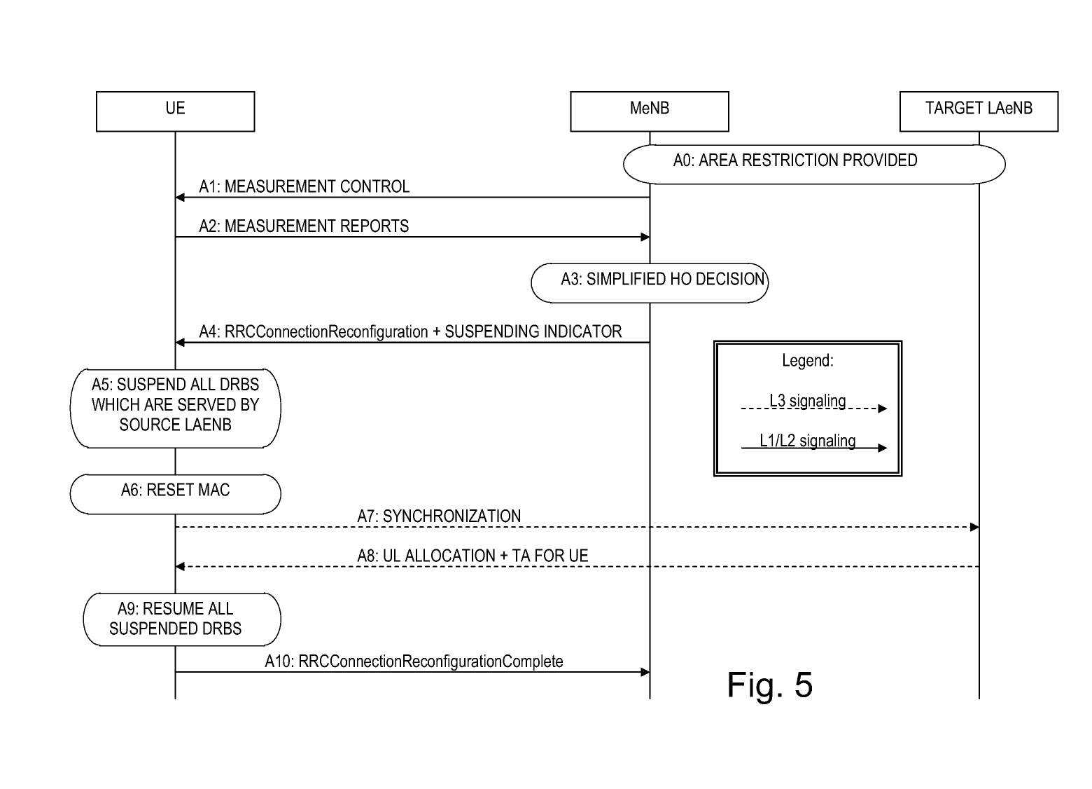

In the following, a more concrete implementation of the embodiment described above is described in detail by referring to FIG. 5.

In particular, FIG. 5 illustrates the implementation of the above first to third items of the embodiment from simplified HO procedure point of view.

The whole procedure for HO under C/U-plane split assumption is shown in FIG. 5.

The basic situation is as described above, i.e., a simplified handover, namely a handover of a UE to a target LAeNB is to be affected on the U-plane, whereas the control is maintained by the MeNB.

In A0, the UE context within the MeNB contains information regarding roaming restrictions which were provided either at connection establishment or at the last TA update.

In A1, the MeNB configures the UE measurement procedures according to the area restriction information. In particular, the parameters contained in the measurement configuration are to indicate that the measurement is mainly configured to measure LA cells.

In A2, the UE is triggered to send MEASUREMENT REPORT to MeNB by the rules set by i.e. system information, specification etc. In the measurement report, UE may provide one or multiple measurement results information for LA cells.

In A3 the MeNB makes the simplified HO decision based on MEASUREMENT REPORT and RRM information to set U-plane for UE, i.e. MeNB will select one LA cell from UE's measurement report to establish DRBs for UE.

In A4, the MeNB generates the RRC message to perform the handover, i.e. RRCConnectionReconfiguration message without the mobilityControlInformation. In addition, a suspending indicator is sent to UE. This indicator can be explicit. It is noted that the source LAeNB does not need to perform the integrity protection and ciphering of the message, due to the same PDCP entity at BB units for all LAeNBs. Moreover, data forwarding between source LAeNB and target LAeNB is not needed, due to the same BB units.

In A5, when UE receives these information, the UE suspends all the DRBs that are served by source LAeNB.

In A6, the UE resets its MAC.

In A7, the UE performs synchronization to target LAeNB and accesses the LA cell via RACH, following a contention-based procedure if no dedicated preamble was indicated.

In A8, the target LAeNB responds with UL allocation and timing advance.

In A9, the UE resumes all the suspended DRBs.

In A10, when the UE has successfully accessed the LA cell, the UE sends the RRCConnectionReconfigurationComplete message (C-RNTI) to confirm the simplified HO is successfully completed, along with an uplink Buffer Status Report, whenever possible, to the MeNB to indicate that the simplified HO procedure is completed for the UE.

Thus, according to the embodiment described above, a simplified handover can reliably be carried out in a C/U-plane split situation.

Embodiments of the present invention can provide the following advantages:

The existing mechanism can be reused as much as possible for HO operation, i.e. it is possible to minimize the change from the UE and NW point of view. This reduces costs and effort for such a change.

Moreover, HO latency and signaling load are greatly reduced. Namely, compared with normal HO procedure (FIG. 3), no HO request, SN status transfer, data exchange between source LAeNB and target LAeNB are needed in this simplified HO procedure. Furthermore, no MME and serving gateway are involved.

In addition, compared with normal RRC connection control procedure (FIG. 4), only DRBs are handled, and PDCP/RLC re-establishments are ignored in the proposed procedure.

It is noted that the invention is not limited to the specific embodiments as described above.

Embodiments of the present invention may be implemented in software, hardware, application logic or a combination of software, hardware and application logic. The software, application logic and/or hardware generally, but not exclusively, may reside on the devices' modem module. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, a mobile phone or a smart phone, or user equipment.

The present invention relates in particular but without limitation to mobile communications, for example to environments under LTE, WCDMA, WIMAX and WLAN and can advantageously be implemented in user equipments, mobile phones or smart phones, or personal computers connectable to such networks. That is, it can be implemented as/in chipsets to connected devices, and/or modems or other modules thereof.

If desired, at least some of different functions discussed herein may be performed in a different order and/or concurrently with each other. Furthermore, if desired, one or more of the above-described functions may be optional or may be combined.

According to a further aspect of embodiments of the present invention, there is provided an apparatus comprising
means for controlling a first type cell, wherein a plurality of second type cells are located in the same area as the first type cell, wherein control signal transmission to at least one user equipment is carried out via the first type cell and data transmission to the at least one user equipment is carried out via one of a plurality of the second type cells, and
means for controlling handover of data transmission of a user equipment from a source cell being one of the plurality of second type cells to a target cell being another one of the plurality of second type cells.

According to another aspect of embodiments of the present invention, there is provided an apparatus comprising
having control signal transmission with a first type cell and data transmission with one of a plurality of second type cells, wherein the plurality of second type cells are located in the same area as the first type cell, and
performing a handover of data transmission from a source cell being one of the plurality of second type cells to a target cell being another one of the plurality of second type cells, while maintaining control signal transmission with the first type cell.

It is to be understood that any of the above modifications can be applied singly or in combination to the respective aspects and/or embodiments to which they refer, unless they are explicitly stated as excluding alternatives.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-7. (canceled)

8. An apparatus comprising
at least one processor, and
at least one memory including computer program code,
the at least one memory and the computer program being configured to, with the at least one processor, cause the apparatus
to have control signal transmission with a first type cell and data transmission with one of a plurality of second type cells, wherein the plurality of second type cells are located in the same area as the first type cell, and
to perform a handover of data transmission from a source cell being one of the plurality of second type cells to a target cell being another one of the plurality of second type cells, while maintaining control signal transmission with the first type cell.

9. The apparatus according to claim 8, wherein
the at least one memory and the computer program are configured to, with the at least one processor, cause the apparatus
to receive a request to perform handover related measurements from the first type cell,
to perform the measurements, and
to send a measurement report to the first type cell.

10. The apparatus according to claim 9, wherein
the at least one memory and the computer program are configured to, with the at least one processor, cause the apparatus
to receive a command from the first type cell to reconfigure a radio resource connection with the target cell and to maintain control signal connection with the first type cell.

11. The apparatus according to claim 10, wherein the command is a RRCConnectionReconfiguration message without mobility Control Information.

12. The apparatus according to claim 10, wherein
the at least one memory and the computer program are configured to, with the at least one processor, cause the apparatus
to receive an indication to suspend data transmission with the source cell,
to suspend the data transmission with the source cell, and
to establish data transmission with the target cell.

13. The apparatus according to claim 12, wherein
the at least one memory and the computer program are configured to, during establishing data transmission with the target cell, reset a medium access control function, to perform synchronization with the target cell, and to resume data transmission with the target cell.

14. The apparatus according to claim 12, wherein
the at least one memory and the computer program are configured to send, after successfully establishing data transmission with the target cell, a message to the first type cell that the handover is successfully completed.

15. The apparatus according to claim 8, wherein data transmission is carried out on data radio bearers and control signal transmission is carried out on signaling radio bearers.

16. The apparatus according to claim 8, wherein the apparatus is or is part of a user equipment.

17. The apparatus according to claim 16, wherein the user equipment is a mobile phone.

18. The apparatus according to claim 8, wherein the apparatus is configured for use in a long term evolution system and/or long term evolution advanced system.

19-25. (canceled)

26. A method comprising
having control signal transmission with a first type cell and data transmission with one of a plurality of second type cells, wherein the plurality of second type cells are located in the same area as the first type cell, and
performing a handover of data transmission from a source cell being one of the plurality of second type cells to a target cell being another one of the plurality of second type cells, while maintaining control signal transmission with the first type cell.

27. The method according to claim 26, further comprising
receiving a request to perform handover related measurements from the first type cell,
performing the measurements, and
sending a measurement report to the first type cell.

28. The method according to claim 27, further comprising
receiving a command from the first type cell to reconfigure a radio resource connection with the target cell and to maintain control signal connection with the first type cell.

29. The method according to claim 28, wherein the command is a RRCConnectionReconfiguration message without mobility Control Information.

30. The method according to claim 28, further comprising
receiving an indication to suspend data transmission with the source cell,
suspending the data transmission with the source cell, and
establish data transmission with the target cell.

31. The method according to claim 30, further comprising,
during establishing data transmission with the target cell, resetting a medium access control function, performing synchronization with the target cell, and resuming data transmission with the target cell.

32. The method according to claim 30, further comprising
sending, after successfully establishing data transmission with the target cell, a message to the first type cell that the handover is successfully completed.

33. The method according to claim 26, wherein data transmission is carried out on data radio bearers and control signal transmission is carried out on signaling radio bearers.

34. The method according to claim 26, wherein the method is configured for use in a long term evolution system and/or long term evolution advanced system.

35. (canceled)

36. A non-transitory computer program product comprising computer-executable components which, when executed on a computer, are configured to carry out the method as defined in claim 26.
